(19) United States
(12) Patent Application Publication
(10) Pub. No.: US 2006/0212869 A1
(43) Pub. Date: Sep. 21, 2006

(54) Resource management method and apparatus

(75) Inventors: Reinder Jaap Bril, Eindhoven (NL); Dietwig Jos Clement Lowet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/552,805

(22) PCT Filed: Apr. 5, 2004
(86) PCT No.: PCT/IB04/50393

§ 371 Date: Oct. 11, 2005

(30) Foreign Application Priority Data
Apr. 14, 2003 (EP) 03100996.2

(51) Int. Cl. G06F 9/46

(52) U.S. Cl. 718/102

(57) ABSTRACT

This invention is concerned with apparatus and a method for resource management and is particularly suited to resource management of real-time systems. In particular, the invention is concerned with memory management of applications running on low cost systems where the amount of main memory is limited. The invention provides a method of scheduling a plurality of tasks in a data processing system, each task having suspension data specifying suspension of the task based on memory usage associated therewith, the method including: processing one of the plurality of tasks; monitoring for an input indicative of memory usage of the task matching the suspension data associated with the task; suspending processing of said task on the basis of said monitored input; and processing a different one of the plurality. Thus in the invention, tasks to be executed on such a system are preconfigured with suspension data, otherwise referred to as memory-based preemption points, which specify the amounts of memory required at various points in a task's execution (i.e. at and between preemption points). The data processing system is equipped with corresponding processing means arranged to evaluate whether, on the basis of the task(s) to be processed and the available memory, scheduling of the tasks should be constrained. The invention thus provides a means of preempting task processing based on memory constraints, and as such provides both a new memory management method and a new preemptive criterion.

The present invention relates to a resource management method and apparatus therefor and is particularly, but not exclusively, suited to resource management of real-time systems.

The management of memory is a crucial aspect of resource management, and various methods have been developed to optimise its use. One method is so-called “virtual memory”, where a computer appears to have more main (or primary) memory than it actually has by swapping unused resources out of primary memory and onto second memory, e.g. the hard drive, and replacing them with those required to execute the current operation.

Virtual memory is used either when the memory requirements of an application exceed the primary memory available or when an application needs to access a resource that is not resident in primary memory. In the latter situation, a virtual memory manager locates an unused memory page (one that has not been accessed recently, for example), and writes the unused page out to a reserved area of disk called the swap file. The virtual memory manager then causes the CPU to read the requested page into primary memory, from either a file on disk or the swap file. As this is done, the virtual memory manager maps the first and second memory pages and performs some internal housekeeping.

For more information the reader is referred to Part 3 (Chapter 7) of: “H. M. Deitel, An introduction to Operating Systems, Addison Wesley Publishing Company, Inc., ISBN 0-201-14502-2, 1984.”

With adequate main memory, virtual memory is seldom used. With insufficient memory, the computer spends most of its time moving pages between memory and the swap file, which is slow, since a hard drive access is more than 1,000 times slower than a memory access. In addition, the requisite movement of data increases non-determinism, and reduces the predictability of the system. Virtual memory thus facilitates an increase of storage capacity at a lower cost per bit, but with an increase in worst-case access time and non-deterministic behaviour from a timing-perspective.

Another method of memory management involves selecting and processing a file in dependence on available memory. This method is particularly suited to certain types of files, such as image files, which are extremely resource intensive. Processing such files involves selecting, from several different versions of the file (each of which corresponds to a different resolution, or Quality of Service (QoS)), a version on the basis of its processing requirements and memory availability. In the case of image files, the different resolution versions can be stored in different video tracks in the image file; this method is currently employed by Apple™, in their QuickTime VR™ application. The problem with this approach is that a plurality of versions of the image needs to be made available, which is inconvenient and costly.

The processing of applications and data appears to remorselessly involve an increasing amount of resources, meaning that computers constantly require upgrading. For System on Silicon or System on a Chip devices, memory is, in any given case, becoming a dominant limiting factor, since, from the point of view of the amount of silicon area needed, adding another processing core (such as a MIPS or a VLIW) is no longer a problem. As a consequence, memory, rather than CPU-cycles, is likely to become a bottleneck for new generations of systems.

It would be desirable if there were a memory management method that does not necessitate procurement of additional memory, and is less processor intensive and thus cheaper than existing methods.

According to a first aspect of the invention there is provided a method of scheduling a plurality of tasks in a data processing system, each task having suspension data specifying suspension of the task based on memory usage associated therewith, the method including:

processing one of the plurality of tasks;

monitoring for an input indicative of memory usage of the task matching the suspension data associated with the task;

suspending processing of said task on the basis of said monitored input; and

processing a different one of the plurality.

In the following description, suspension of a task is referred to as task preemption, or preemption of a task, and the term “task” is used to denote a unit of execution that can compete on its own for system resources such as memory, CPU, I/O devices etc. In one embodiment a task can be viewed as a succession of continually executing jobs, each of which comprises one or more sub-jobs. For example, a task could comprise “demultiplexing a video stream”, and involve reading in incoming streams, processing the streams and outputting data in respect thereof. These steps would be carried out in respect of each incoming data stream, so that reading, processing and outputting in respect of a single stream corresponds to performing one job; thus when there is a plurality of packets of data to be read in and processed, the job would be performed a corresponding plurality of times. A sub-job can be considered to relate to a functional component of the job.

In embodiments of the invention, the amount of memory that is used by the data processing system is indirectly controlled by the suspension data, via so-called preemption points, which specify the amounts of memory required at various points in a task's execution.

These preemption points are utilized to avoid the data processing system crashing through lack of memory. When a real-time task is characterized as comprising a plurality of sub-jobs, the preemption points preferably coincide with sub-job boundaries of the task. In the following description, the suspension data is referred to as preemptive memory data or simply memory data.

In one arrangement, the input (indicative of memory usage of the task matching the suspension data associated with the task) is received from a task requesting a descheduling event; preemption points can, for example, be embedded into a task via a line of code that requests a descheduling event, specifying that a preemption point has occurred. In an alternative arrangement, the input can be the amount of memory being used by a task, so that the monitoring step would then involve monitoring the actual memory usage against the suspension data associated with that task.

Conveniently the method includes receiving first data identifying maximum memory usage associated with each of the plurality of tasks; receiving second data identifying memory available for processing the plurality of tasks; and identifying, on the basis of the first and second data, whether there is sufficient memory available to process the tasks. The said monitoring and suspending steps are then applied only in response to identifying insufficient memory.

In this arrangement, the data processing system only makes use of the suspension, or preemption, points if it otherwise has insufficient memory to process all of the tasks simultaneously.

Conveniently the method includes monitoring termination of tasks and repeating said step of identifying availability of memory in response to a task terminating. In one arrangement, if, after a task has terminated, there is sufficient memory to execute the remaining tasks simultaneously, the monitoring step is deemed unnecessary and tasks are allowed to progress without any monitoring of inputs in relation to memory usage. In a second arrangement the method could include processing a non real-time task whilst monitoring for inputs in relation to memory usage of the other tasks.

In a second aspect of the invention there is provided a scheduler for use in a data processing system, the data processing system being arranged to execute a plurality of tasks and having access to a specified amount of memory for use in executing the tasks, the scheduler comprising:

a data receiver arranged to receive data identifying maximum memory usage associated with a task;

an evaluator arranged to identify, on the basis of the received data, whether there is sufficient memory to execute the tasks;

a selector arranged to select at least one task for suspension during execution of the task, said suspension coinciding with a specified memory usage by the task;

wherein, in response to the evaluator identifying that there is insufficient memory to execute the plurality of tasks, the selector selects one or more tasks for suspension, on the basis of their specified memory usage and the specified amount of memory available to the data processing system, and the scheduler suspends execution of the or each selected task in response to the task using the specified memory.

Advantageously the scheduler could be implemented in hardware or software, and the data processing system could be a high volume consumer electronics device such as a digital television system.

According to a third aspect of the invention there is provided a method of transmitting data to a data processing system, the method comprising:

transmitting data for use by the data processing system in processing a task; and

transmitting suspension data specifying suspension of the task based on memory usage during processing thereof, wherein the data processing system is arranged to perform a process comprising:
monitoring for an input indicative of memory usage of the task matching the suspension data associated with the task; and
suspending processing of said task.

This third aspect is therefore concerned with the distribution of the suspension, or pre-emptive, data corresponding to tasks to be processed. The suspension data can be distributed as part of a regularly broadcasted signal (e.g. additional tasks with suspension data accompanying other sources), or distributed by a service provider as part of a general upgrade of data processing systems. Moreover, the data processing system could be updated via a separate link, or device (e.g. floppy-disk or CD-ROM).

An additional benefit of embodiments of the invention is that a data processing system can be configured with less memory than is possible at present, which means that the cost of the processing device using the memory will be lower. In addition, or alternatively, predictability is improved due to removing the need to access off-chip memory or secondary memory.

Unless the context indicates otherwise, the term “memory” is used in the following description to denote random access memory.

Further objects, advantages and features of the invention will be apparent from the following more particular description of preferred embodiments of the invention, as illustrated in the accompanying drawings, in which:

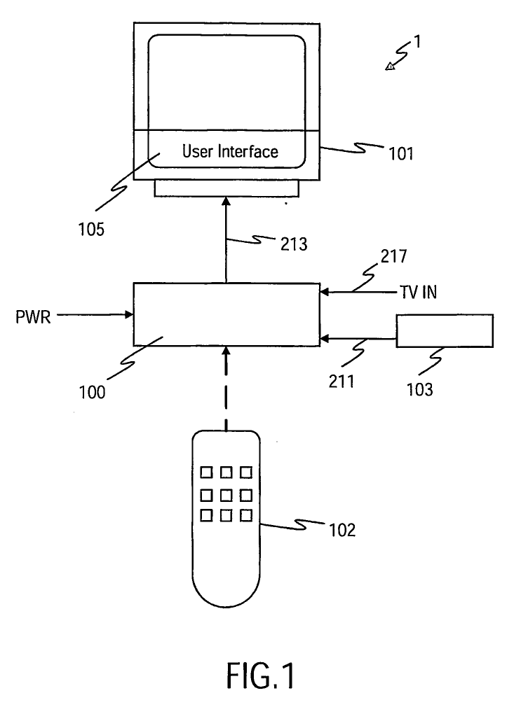

FIG. 1 is a schematic diagram showing an example of a digital television system in which an embodiment of the invention operates;

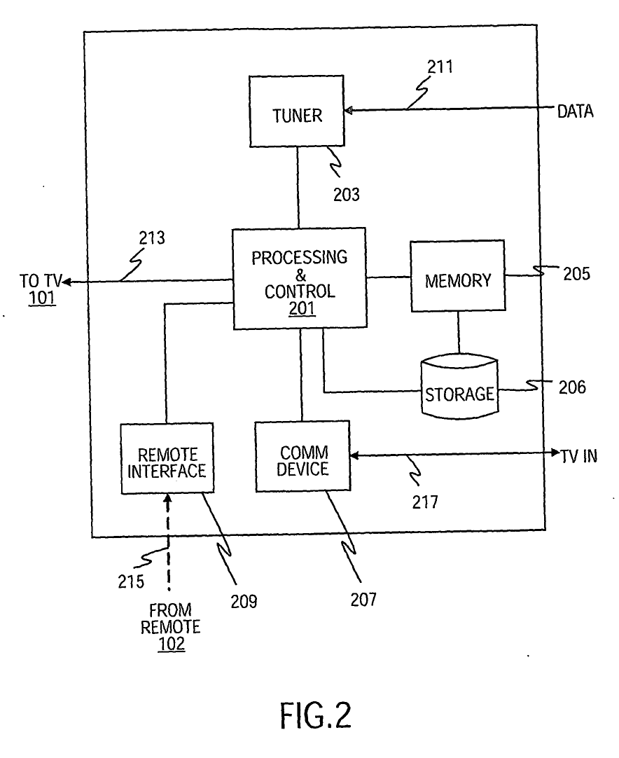

FIG. 2 is a schematic block diagram showing, in greater detail, components constituting the set top box of FIG. 1;

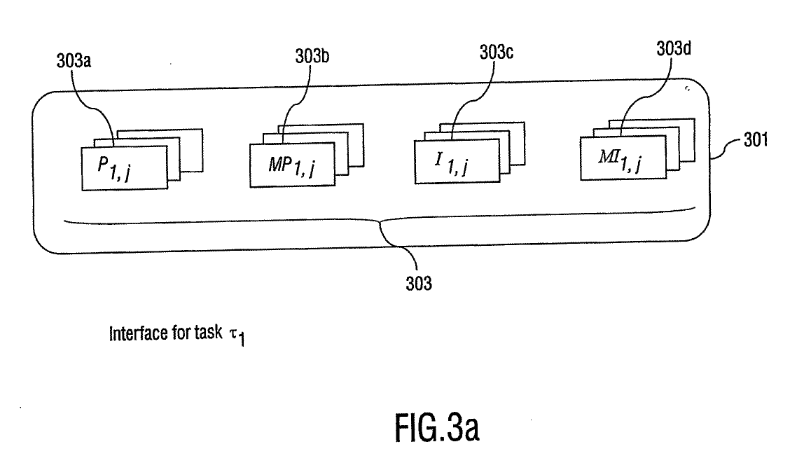

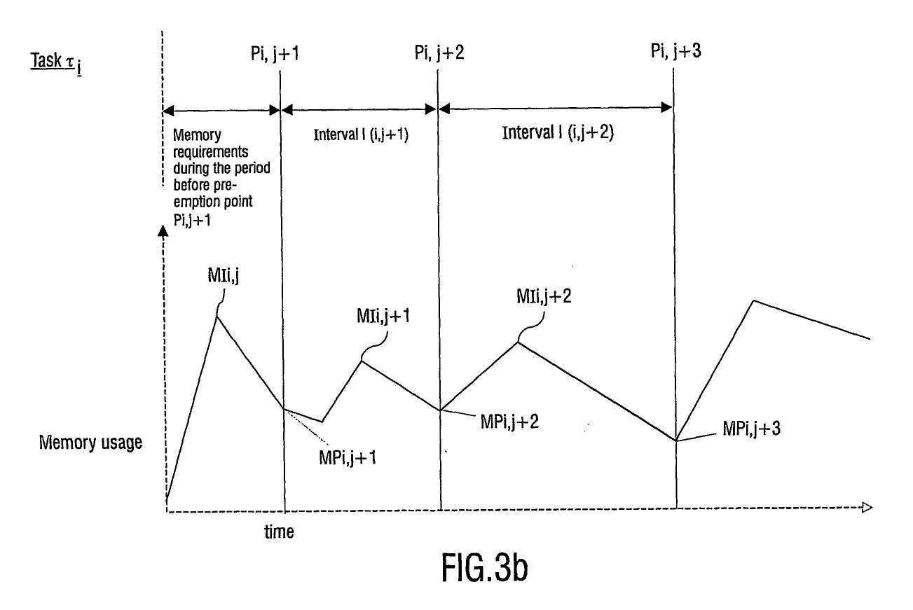

FIG. 3a is a schematic diagram showing components of a task interface according to an embodiment of the invention;

FIG. 3b is a schematic diagram showing the relationship between components of the task interface shown in FIG. 3a;

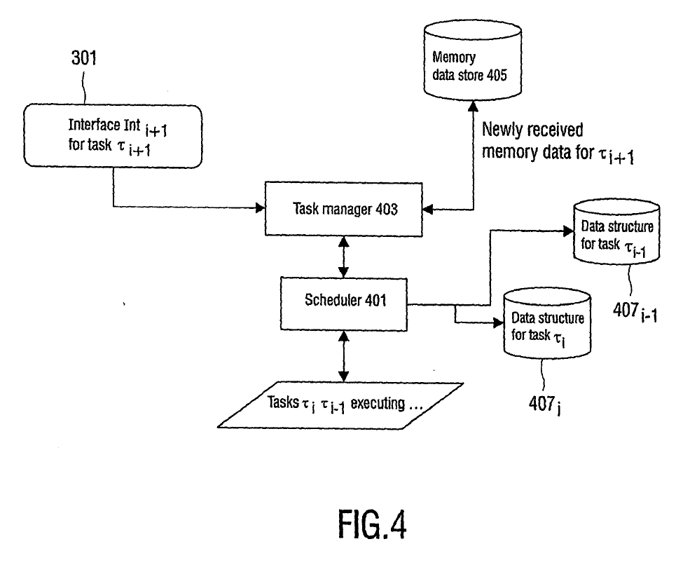

FIG. 4 is a schematic block diagram showing components of the processor of the set-top box shown in FIGS. 1 and 2, according to an embodiment of the invention;

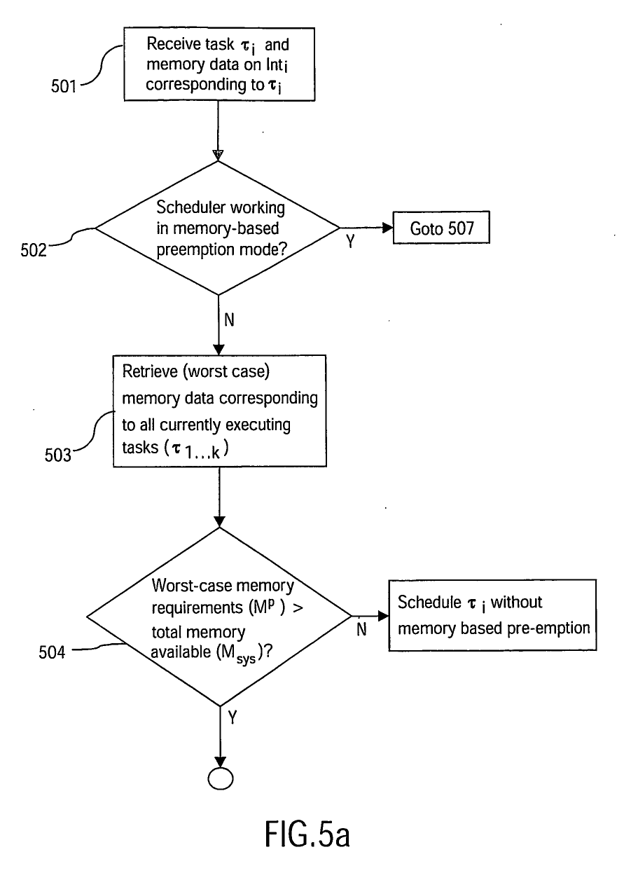

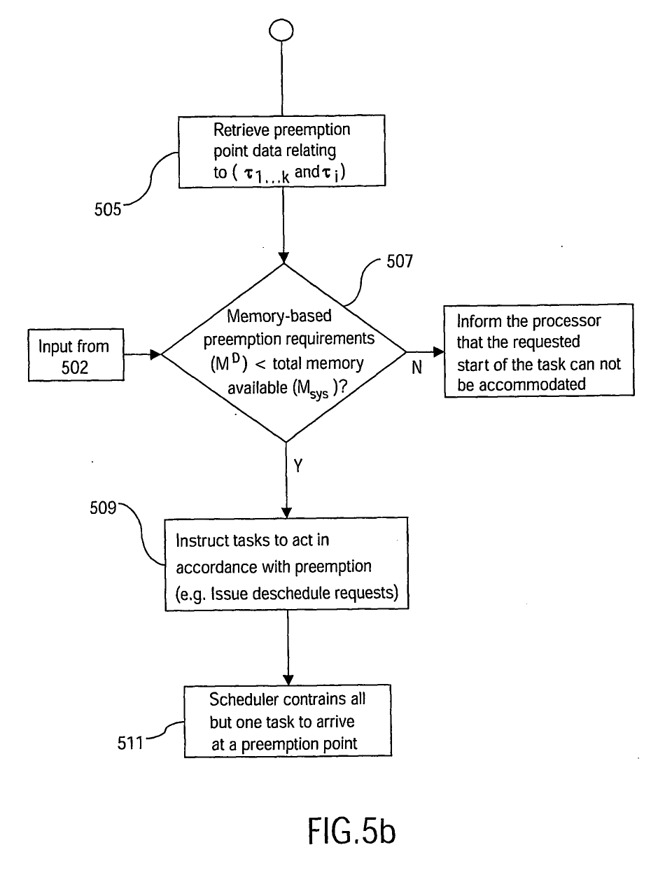

FIGS. 5a and 5b are collectively a flow diagram showing steps carried out by the components of FIG. 4;

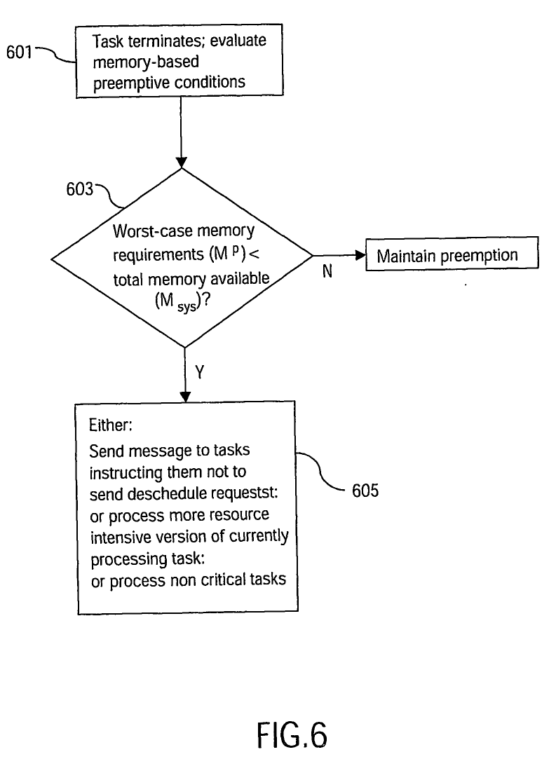

FIG. 6 is a flow diagram showing further steps carried out by the components of FIG. 4; and

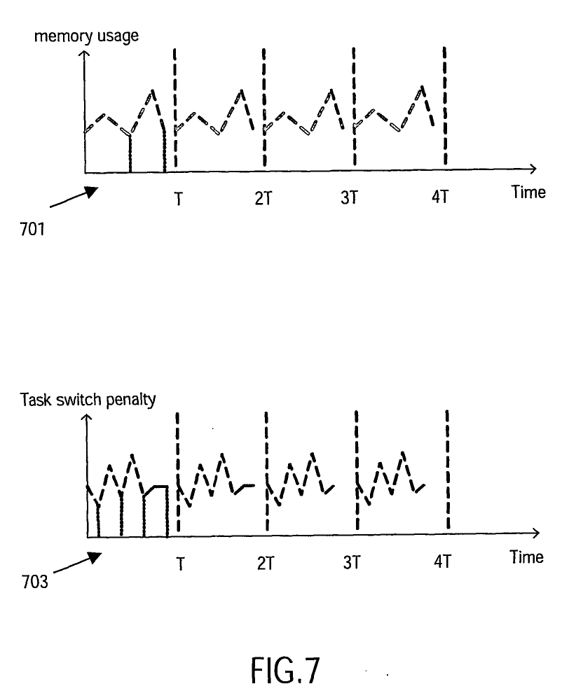

FIG. 7 is a schematic diagram showing memory usage and task switch penalty associated with processing a periodic task.

In at least some embodiments, a task comprises a real-time task, where data are processed and/or delivered within some time constraints, and where some degree of precision in scheduling and execution of the task is required. Examples of real-time tasks include multimedia applications having video and audio components (including making of a CD), video capture and playback, telephony applications, speech recognition and synthesis, while devices that process such tasks include consumer terminals such as digital TVs and set-top boxes (STB), and computers arranged to process the afore-described multimedia applications.

In the field of High Volume Consumer Electronics (HVE), a digital television system is expected to process and display a plurality of different and unrelated images and to receive and process input from the user (the user input ranging from, e.g., simple channel changing to interactive feedback). For example, viewers commonly want to watch a film whilst monitoring the progress of a football match. To accommodate these needs, the digital television system can be arranged to display the football match in a relatively small window (known as Picture-in-Picture (PiP)) located at the corner of a television screen whilst the film occupies the remainder of the screen; both display areas would be constantly updated and the user would be able to switch focus between the two at any time. This example thus involves two applications, one having the main window as output and the other having the PiP window as output. The digital television system is arranged to process two independent streams, one corresponding to the main window and one corresponding to the PiP window, and each stream typically comprises multiple real-time tasks for data processing (for both audio and video).

Consumer products such as a set-top box are expected to be robust and to meet the stringent timing requirements imposed by, for example, high-quality digital audio and video processing; consumers simply will not tolerate their television set crashing, with a message asking them to “please reboot the system”. However, at the same time, system resources, and in particular memory, have to be used very cost-effectively in such consumer products.

A set-top box is thus an example of a system having real-time constraints. As shown in FIG. 1, in a conventional arrangement, a set-top box 100 is connected to a television 101 and a content provider (or server) 103 via a television distribution system 1, and is arranged to receive data from content provider 103 for display on the television 101. The set top box 100 also receives and responds to signals from a user interface 105, which may comprise any well known user interface that is capable of providing selection signals to the set top box 100. In one arrangement, the user interface 105 comprises an infrared remote control interface for receiving signals from a remote control device 102.

The set top box 100 receives data either via an antenna or a cable television outlet, and either processes the data or sends it directly to the television 101. A user views information displayed on television 101 and, via user interface 105, inputs selection information based on what is displayed. Some or all of the user selection signals may be transmitted by the set top box 100 to the content provider 103. Signals sent from the set top box 100 to the server 103 include an identification of the set top box 100 and the user selection. Other information may also be provided depending upon the particular implementation of the set top box 100 and the content provider 103.

FIG. 2 is a conceptual diagram showing the internal components of the set-top box 100; it is intended to be a conceptual diagram and does not necessarily reflect the exact physical construction and interconnections of these components. The set top box 100 includes a processing and control unit 201 (herein after referred to as a processor), which controls the overall operation of the box 100. Coupled to the processor 201 are a television tuner 203, a memory device 205, storage 206, a communication device 207, and a remote interface 209. The television tuner 203 receives the television signals on transmission line 211, which, as noted above, may originate from an antenna or a cable television outlet. The processor 201 controls operation of the user interface 105, providing data, audio and video output to the television 101 via line 213. The remote interface 209 receives signals from the remote control via the wireless connection 215. The communication device 207 is arranged to transfer data between the box 101 and one or more remote processing systems, such as a Web server, via data path 217. The communication device 207 may be a conventional telephone (POTS) modem, an Integrated Services Digital Network (ISDN) adapter, a Digital Subscriber Line (xDSL) adapter, a cable television modem, or any other suitable data communication device.

An embodiment of the invention will now be described in more detail. It is assumed that the processor 201 is arranged to process a plurality of tasks relating to control of the set-top box, such as changing channel; selection of a menu option displayed on the Graphical User Interface (GUI) 105; interaction with Teletext; decoding incoming data; and recording data on the storage 206 currently viewed on the television 101 etc. In general, such control tasks determine the operational settings of the set-top box 100, based on: characteristics of the set-top box 100; incoming video signal (via line 211); user inputs; and any other ancillary input. Referring to FIG. 3a, such tasks are accompanied by a programmable interface 301, which includes preemptive memory data 303 corresponding to the task. In the FIG. 3a memory data 303 corresponding to a single task τ₁ are shown for the case of task τ₁ having 3 preemption points 6=3).

As is known in the art, a component (e.g. a software component, which can comprise one or more tasks) can have a programmable interface that comprises the properties, functions or methods and events that the component defines (for more information the reader is referred to Clemens Szyperski, Component Software—Beyond Object-oriented Programming, Addison-Wesley, ISBN 0-201-17888-5, 1997.”). In the present embodiment, a task is accompanied by an interface which includes, at a minimum, main memory data required by the task.

For the purposes of the present example, a task is assumed to be periodic and real-time, and characterized by a period T and a phasing F, where 0<=F<T, which means that a task can be considered to comprise a sequence of jobs, each of which is released at time F+nT, where n=0 . . . N. The set-top box 100 is assumed to execute three tasks—display menu on the GUI 105; retrieve teletext information from the content provider 103; and process some video signals—and each job of these 3 tasks is assumed to comprise a plurality of sub-jobs. For ease of presentation, it is assumed that the sub-jobs are executed sequentially.

At least some of these sub-jobs can be preempted; the boundaries between those subjobs that can be preempted provide preemption points and are summarized in Table 1:

TABLE 1

| | | Number of |
|---|---|---|
| | | preempt-able sub- |
| Task τᵢ | Task description | jobs of task τᵢ (m(i)) |
| τ₁ | display menu on the GUI | 3 |
| τ₂ | retrieve teletext information from content | 2 |
| | provider | |
| τ₃ | process video signals | 2 |

Referring also to FIG. 3b, for each task, the memory data 303 comprises: information relating to a preemption-point (P_{i,j}), such as the maximum amount of memory MP_{i,j} required at the preemption point; and information between successive preemption-points, such as the worst-case amount of memory MI_{i,j} required in an intra-preemption point interval (i represents task τᵢ and j represents a preemption point).

More specifically, memory data 303 comprises data specifying: preemption point j of the task τᵢ (P_{i,j}) 303a; maximum memory requirements of task τᵢ, MP_{i,j}, at preemption point j of that task, where 1≦j≦m(i) 303b; interval, I_{i,j}, between successive preemption points j and (i+1) corresponding to sub-job j of task τᵢ, where 1≦j≦m(i) 303c; and maximum (i.e. worst-case) memory requirements of task τᵢ, MI_{i,j}, in the interval j of that task, where 1≦j≦m(i) 303d.

Table 2 illustrates the memory data 303 for the current example (each task will have its own interface, so that in the current example, the memory data 303 corresponding to the first task τ₁ comprises the data in the first row of Table 2; data 303 corresponding to the second task τ₂ comprises the second row of Table 2 etc.):

TABLE 2

| Task τᵢ | MP_{i,1} | MI_{i,1} | MP_{i,2} | MI_{i,2} | MP_{i,3} | MI_{i,3} |
|---|---|---|---|---|---|---|
| τ₁ | 0.2 | 0.7 | 0.2 | 0.4 | 0.1 | 0.6 |
| τ₂ | 0.1 | 0.5 | 0.2 | 0.8 | — | — |
| τ₃ | 0.1 | 0.2 | 0.1 | 0.3 | — | — |

One of the problems addressed by embodiments of the invention can be seen when we consider how a set-top box 100, equipped with 1.5 Mbytes of memory, will behave under normal, or non-memory based preemptive, conditions.

In a conventional arrangement the processor 201 may be expected to schedule tasks according to some sort of time slicing or priority based preemption, meaning that all 3 tasks run concurrently, i.e. effectively at the same time. It is therefore possible that each task could be scheduled to run its most memory intensive sub-job at the same time. The worst-case memory requirements of these three tasks, M^{P}, is given by:

$${M}^{P} = {\sum }_{i = 1}^{3} {max}_{j = 1}^{m ( i )} {MI}_{i , j} \qquad ( Equation 1 )$$

For tasks τ₁, τ₂ and τ₃M^{P} is thus the maximum memory requirements of τ₁ (being MI_{1,1}) plus the maximal memory requirements of task τ₂ (being MI_{2,2}) plus the maximal memory requirements of task 3 (being MI_{3,2}). These maximum requirements are indicated by the table entries in bold:
M^{P}=0.7+0.8+0.3=1.8 Mbytes.

This exceeds the memory available to the set-top box 100 by 0.3 Mbytes, so that, in the absence of any precautionary measures, and if these sub-jobs were to be processed at the same time, the set-top box 100 would crash.

As will now be described with reference to FIGS. 4, 5a, 5b and 6, in this embodiment the processor 201 makes use of memory data 303 to ensure that such a situation will not occur. Essentially, the embodiment includes steps which may be carried out by elements of the processor 201 executing sequences of instructions. The instructions may be stored in storage 206 and embodied in one or a suite of computer programs, written, for example, in the C programming language.

The features of embodiments are described primarily in terms of functionality; the precise manner in which this functionality is implemented, or “coded”, is not important for an understanding of the present invention. Many implementations (procedural or object-oriented) are possible and would be readily appreciated from this description by one skilled in the relevant art.

FIG. 4 is a schematic diagram showing those components of the processor 201 that are relevant to embodiments of the invention, including scheduler 401 and task manager 403. The scheduler 401 schedules execution of tasks in accordance with a scheduling algorithm and creates and maintains a data structure 407ᵢ for each task τᵢ after it has been created. Preferably the scheduler 401 employs a conventional priority-based, preemptive scheduling algorithm, which essentially ensures that, at any point in time, the currently running task is the one with the highest priority among all ready-to-run tasks in the system. As is known in the art, the scheduling behaviour can be modified by selectively enabling and disabling preemption for the running, or ready-to-run, tasks.

The task manager 403 is arranged to receive the memory data 303 corresponding to a newly received task and evaluate whether preemption is required or not; if it is required, it is arranged to pass this newly received information to the scheduler 401, requesting preemption. The functionality of the task manager 403, and steps carried out by the tasks and/or scheduler 401 in response to data received from the task manager 403 will now be described in more detail, with reference to FIGS. 4, 5a and 5b. FIGS. 5a and 5b are collectively a flow diagram showing steps carried out by the task manager 403 when receiving details of the tasks defined in Table 2, assuming that task τ₁ (and only τᵢ) is currently being processed by the processor 201, and that the scheduler 401 is initially operating in a mode in which there are no memory-based constraints.

At step 501 task τ₂ is received by the task manager 403, which reads the memory data 303 from interface Int₂, and identifies whether or not the scheduler 401 is working in accordance with memory-based preemption (step 502); since, in this example, it is not, the task manager 403 evaluates whether the scheduler 401 needs to change to memory-based preemption. This therefore involves the task manager 403 retrieving at step 503 worst case memory data corresponding to all currently executing tasks (in this example task τ₁) from memory data store 405, evaluating Equation 1 and comparing the evaluated worst-case memory requirements with memory resource available to the processor 201 (step 504). Continuing with the example introduced in Table 2, Equation 1, for τ₁ and τ₂, is:
M^{P}=Σᵢ₌₁²=maxⱼ₌₁^{m(i)}MI_{i,j}=0.7+0.8=1.5 MBytes

This is exactly equal to the available system requirements, so there is no need to change the mode of operation of the scheduler to memory-based preemption (i.e. there is no need to constrain the scheduler 401 based on memory usage). Thus, if the scheduler 401 were to switch between task τ₁ and task τ₂—e.g. to satisfy execution time constraints of task τ₂, meaning that both tasks effectively reside in memory at the same time—the processor 201 will never access more memory than is available.

Next, and before tasks τ₁ and τ₂ have completed, another task τ₃ is received (step 501). The task manager 403 proceeds to step 503 and reads the memory data 303 from interface Int₃ associated with the task τ₃, evaluating whether the scheduler needs to change to memory-based preemption. Assuming that the scheduler is multi-tasking tasks τ₁ and τ₂, the worst case memory requirements for all three tasks is now
M^{P}=Σᵢ₌₁³=maxⱼ₋₁^{m(i)}MI_{i,j}=0.7+0.8+0.3=1.8 MBytes

This exceeds the available system resources, so at step 505 the task manager 403 requests and retrieves memory usage data MP_{i,j},MI_{i,j} 303b, 303d in respect of all 3 tasks from memory data store 405, and evaluates whether, based on this retrieved memory usage data, there are sufficient resources to execute all 3 tasks (step 507). This can be ascertained through evaluation of the following equation:

$$\begin{matrix}{M}^{D} = {\sum }_{i = 1}^{3} {max}_{j = 1}^{m ( i )} {MP}_{i , j} + {max}_{i = 1}^{3} ( {max}_{j = 1}^{m ( i )} {MI}_{i , j} - {max}_{j = 1}^{m ( i )} {MP}_{i , j} ) \\ = 0.2 + 0.2 + 0.1 + \\ max ( 0.7 - 0.2 , 0.8 - 0.2 , 0.3 - 0.1 ) \\ = 0.5 + 0.6 \\ = 1.1 Mbytes .\end{matrix} \qquad ( Equation 2 )$$

This memory requirement is lower than the available memory, meaning that, provided the tasks are preempted based on their memory usage, all three tasks can be executed concurrently.

Accordingly, the task manager 403 invokes “memory-based preemption mode” by instructing (step 509) the tasks to transmit deschedule instructions to the scheduler 401 at their designated preemption points (MP_{i,j}). In this mode, the scheduler 401 allows each task to run non-preemptively from a preemption point to the next preemption point, with the constraint that, at any point in time, at most one task at a time can be at a point other than one of its preemption points. Assuming that the newly arrived task will start at a preemption point, the scheduler 401 ensures (step 511) that this condition holds for the currently running tasks, thereby constraining all (but one) tasks to arrive at a preemption point. This is best explained in the context of the current example: if the task manager 403 were to invoke the memory-based preemption mode while task τ₁ is executing sub-job 2 and task τ₂ is waiting to process sub-job 1, the condition of ensuring that at most one sub-job is being processed would automatically be satisfied. However, if task r, were executing sub-job 2 and task τ₂ were waiting to continue executing sub-job 2, the scheduler 401 would allow task al to complete its sub-job and arrive at preemption point MP_{1,3} before allowing task τ₂ to continue.

Thus in the memory-based pre-emption mode, the scheduler 401 is only allowed to preempt tasks at their memory preemption points (i.e. in response to a deschedule request from the task at their memory-based pre-emption points).

FIG. 6 is a flow diagram that illustrates the steps involved when one of the tasks has terminated, in the event that the task informs the task manager 403 of its termination: at step 601 the terminating task informs the task manager 403 that it is terminating, causing the task manager 403 to evaluate 603 Equation 1; if the worst case memory usage (taking into account removal of this task) is lower than that available to the processor 201, the task manager 403 can cancel at step 605 memory-based preemption, which has the benefit of enabling the system to react faster to external events (since the processor is no longer “blocked” for the duration of the sub-jobs). In general, termination of a task is typically caused by its environment, e.g. a switch of channel by the user or a change in the data stream of the encoding applied (requiring another kind of decoding), meaning that the task-manager 403 and/or scheduler 401 should be aware of the termination of a task and probably even instruct the task to terminate. In such a case step 601 is redundant.

Alternatively, the task manager 403 may select a different version of one of the still executing tasks for processing. Some tasks may have varying levels of service associated therewith, each of which requires access to a different set of resources, and which involves a different a “Quality of Service” (QoS). Bril et al, in “QoS for consumer terminals and its support for product families”, published in Proceedings International Conference on Media Futures, Florence, May 8-9, 2001, pp. 299-303, describes the concept of an application having several versions, each corresponding to a different QoS and thus resource requirement.

As a yet further alternative, the task manager 403 can allow other (non critical; i.e. those with soft constraints) processes to run. These alternatives are merely examples of possible options for the task manager 403/scheduler 401, and do not represent an exhaustive list.

Whilst in the embodiment described above, preemption is only described in the context of main memory requirements, the tasks may additionally be preempted based on timing constraints, such as individual task deadlines and system efficiency. In the example described above, when the tasks are preempted in accordance with their preemption point data 303a, the actual memory usage M^{D} is only 1.1 Mbytes. Thus a further 0.4 Mbytes could be utilised; if the interface were to include data in respect of cache memory usage, the task manager 403 could optimise use of system resources (in terms of overall system efficiency). FIG. 7 shows memory usage 701 and task switch penalty 703 associated with a task that repeatedly processes a job (which itself comprises one or more sub-jobs, as described above) after time T, with the assumption that the main memory usage and task switch penalty are identical for each period (in reality this is unlikely to be the case, since the subjobs may have different execution times in different periods). The task manager 403 may thus know the task switch penalty associated with a task (i.e. the penalty involved with switching between execution loops—fetching sets of instructions from main memory into the cache) in addition to its memory usage, and process an objective function that balances usage of cache memory with main memory. Essentially, memory-based task preemption could be limited to a subset of the preemption point data 303a while invoking some preemption aimed towards minimizing the task switch penalty. Alternatively the memory data 303 could explicitly specify the subset(s), e.g. specifying two or more subsets of preemption points, one subset providing preemption points that optimize cache behaviour, while not exceeding the amount of main memory available, and another subset providing preemption points that minimize main memory requirements.

It should be noted that, when invoked, memory-based preemption constraints according to the invention are obligatory, whereas preemption based on cache memory is purely optional, since cache-based preemption is concerned with enhancing performance rather than operability of a device per se.

Whilst in the above embodiment a task is assumed to be periodic (i.e. processing occurs in predetermined—usually periodic—intervals, and processing deadlines are represented by hard constraints), embodiments can be applied to non-periodic tasks whose processing does not occur in periodic intervals (i.e. where the duration between jobs varies between successive jobs), but whose deadlines are nevertheless represented by hard constraints. Such tasks are typically referred to as sporadic” (real-time tasks that are not periodic, e.g. real-time tasks handling events caused by the end-user because [s]he pressed buttons on a remote control) and “jitter” (fluctuations in duration between activations/releases of periodic tasks).

In the above embodiment we assume that all 3 tasks should be executed as soon as possible after receipt by the scheduler; however, it will be appreciated that the deadline constraints of some tasks can vary significantly between tasks: for example, some tasks may have a deadline of “end of today” (e.g. system management type tasks); whilst others may have a deadline of 5 minutes from receipt by the scheduler. It may be expected, therefore, that some sort of management based on execution times may be employed. For example, step 504 could additionally involve identifying a worse case execution time (WCET) corresponding to the task, and, in the event that the task does not require immediate execution (or which can be executed after one of the more immediately constrained tasks has finished), execution of the task can be postponed, meaning that the system can continue without memory-based preemption. In such a situation the task manager 403 would store details of this not-yet completed task, e.g. in memory data store 405, and perform it at a time that both satisfies its deadline constraints and e.g. coincides with a period of spare capacity (e.g. step 605 of FIG. 6).

Whilst in the embodiment described above the tasks are responsible for initiating pre-emption of a sub-job, the scheduler 401 may alternatively manage this process. Thus in an alternative arrangement, the task manager 403 forwards the preemptive point data 303a to the scheduler. The scheduler 401 examines the data structures 407₁, 407₂ corresponding to currently executing tasks τ₁ and τ₂, in order to identify their respective currently executing sub-jobs. For each task, the scheduler 401 then maps sub-job to preemptive condition in order to identify the next preemption point and, when that point is reached, preempts each of the tasks at that point. This is best explained in the context of the example described above: when the task manager 403 forwards the preemptive point data to the scheduler 401, the scheduler 401 identifies task τ₁ to be executing sub-job 2 and task τ₂ to be waiting to process sub-job 1. Thus the scheduler 401 identifies the next preemption points as: task τ₁ sub-job m(2); task τ₂ sub-job m(1) and prepares to preempt task τ₁ at preemption points MP_{1,2} and MP_{1,3} and task τ₂ at preemption points MP_{2,1} and MP_{2,2}. The scheduler 401 configures task τ₃ so as to preempt at both of its preemption points. This alternative may be useful when the memory usage pattern of tasks is simple, e.g. if the memory usage of a task has two states, one in which a lot of memory is used (“high memory usage”-state) and one in which far less memory is used (“low memory usage”-state). The scheduler 401 monitors the amount of memory each task has allocated, and can be instructed by the task manager not to preempt the task while the task is in “high memory usage” state.

As a further alternative, upon receipt of preemption instructions from the task manager 403 (step 509), a task may raise its priority to a so-called “non-preemptable” priority at the start of a sub-job, and lower its priority to its “normal” priority at the end of the sub-job. In such a situation, the scheduler 401 therefore only has the opportunity to preempt tasks at their preemption points (because that is where the sub-jobs become non-preemptable). The tasks τᵢ will then inform the task manager 403 when they reach preemption points, which enables the task manager 403 to start a different task. In this alternative arrangement, the responsibility for memory-based preemptions lies with the task manager 403 and the tasks τᵢ. This alternative is particularly well suited to the situation where a task comprises a few code-intervals that are extremely memory intensive, and where preemption is only really necessary during processing of these intervals.

Whilst in the above description it is assumed that the invention is embodied in software, certain embodiments of the present invention may be carried out by hard-wired circuitry, rather than by executing software, or by a combination of hard-wired circuitry with software. Hence, it will be recognized that the present invention is not limited to any specific combination of hardware circuitry and software, nor to any particular source for software instructions.

Whilst, as stated in the summary of the invention, the term tasks refers to real-time tasks, the invention can also be used by non-real time tasks, since the invention is primarily a memory management solution. For example, it might be employed in non-real time systems whenever the amount of virtual memory is limited, or use of virtual memory methods is undesirable.

Whilst in the above embodiments it is assumed that tasks are primarily control tasks (providing control of the set-top box 100), the tasks could also include applications designed in accordance with the Multimedia Home Platform (MHP), or other, standard; in this instance, the tasks could include TV commerce; games; and general Internet-based services. Alternatively, the tasks could include control tasks for healthcare devices or tasks for controlling signaling of GSM devices.

Whilst in the above embodiment it is assumed that preemption points are specified on an interface 301, they could alternatively be specified in a log file.

Whilst in the above embodiment the task manager 403 has been described as being separate from the scheduler 401, the skilled person would realize that such segregation serves for descriptive purposes only, and that a conventional scheduler could be modified to include the functionality of both the task manager 403 and the scheduler. Indeed, the physical distribution of components is a design choice that has no affect whatsoever on the scope of the invention.

Whilst in the above embodiment it is assumed that all tasks are processed by a single processor, the tasks could alternatively be processed by a plurality of processors—e.g. set Γ of n tasks πₖ (1≦i≦n) could be processed by a set P of p processors πₖ (1≦k≦p) (where n is typically much larger than p). In one suitable arrangement each task τᵢ is allocated to a particular processor πₖ, meaning that task τᵢ will only execute on processor πₖ. The worst memory requirements, MA, is then given by:

$${M}^{P} = {\sum }_{k = 1}^{p} {M}_{k}^{p} \qquad ( Eq . {1}^{′} )$$

When M^{P} is less than the available memory, there is no need to constrain the scheduling of the tasks on any of the processors (step 504); however, when M^{P} does exceed the available memory, the scheduling of one or more tasks can be constrained to specified one or more processors. The effect of constraining the scheduling of all tasks on a single processor can be determined using an equation such as Equation 2 presented in the context of the first embodiment The effect of constraining the scheduling of all tasks to occur over all available processors can be determined from (Eq. 2′):

$${M}^{D} = {\sum }_{k = 1}^{p} {M}_{k}^{D} \qquad ( Eq . {2}^{′} )$$

where the total memory requirements M^{D} is the sum of the memory requirements MkD of each processor πₖ.

Whilst in the above embodiment the tasks are described as software tasks, a task could also be implemented in hardware. Typically, a hardware device (behaving as a hardware task) is controlled by a software task, which allocates the (worst-case) memory required by the hardware device, and subsequently instructs the hardware task to run. When the hardware task completes, it informs the software task, which subsequently de-allocates the memory. The allocation variant involving multiple processors, described above, also applies to combined SW and HW tasks. Hence, by having a controlling software task, hardware tasks can simply be dealt with in accordance with the above-described embodiment, using modified equations Eq. 1′ and Eq. 2′.

It will be understood that the present disclosure is for the purpose of illustration only and the invention extends to modifications, variations and improvements thereto.

1. A method of scheduling a plurality of tasks in a data processing system, each task having suspension data specifying suspension of the task based on memory usage associated therewith, the method comprising:
processing one of the plurality of tasks;
monitoring for an input indicative of memory usage of the task matching the suspension data associated with the task;
suspending processing of said task on the basis of said monitored input; and
processing a different one of the plurality of tasks.

2. A method according to claim 1, further comprising:
receiving first data identifying maximum memory usage associated with the plurality of tasks;
receiving second data identifying memory available for processing the plurality of tasks; and
identifying, on the basis of the first and second data, whether there is sufficient memory available to process the tasks;
in which said monitoring and suspending steps are applied only in response to identifying insufficient memory.

3. A method according to claim 1, in which said input comprises data indicative of a suspension request.

4. A method according to claim 1, in which said input comprises data indicative of memory usage of the task, the method further comprising identifying when the memory usage matches the suspension data associated with said task.

5. A method according to claim 1, including monitoring termination of tasks and repeating said step of identifying availability of memory in response to a task terminating.

6. A method according to claim 5, in which, in response to identifying sufficient memory to execute the remaining tasks, the monitoring step is deemed unnecessary.

7. A scheduler for use in a data processing system, the data processing system being arranged to execute a plurality of tasks and having access to a specified amount of memory for use in executing the tasks, the scheduler comprising:
a data receiver arranged to receive data identifying maximum memory usage associated with a task;
an evaluator arranged to identify, on the basis of the received data, whether there is sufficient memory to execute the tasks;
a selector arranged to select at least one task for suspension during execution of the task, said suspension coinciding with a specified memory usage by the task;
wherein, in response to the evaluator identifying that there is insufficient memory to execute the plurality of tasks, the selector selects one or more tasks for suspension, on the basis of their specified memory usage and the specified amount of memory available to the data processing system, and the scheduler suspends execution of the or each selected task in response to the task using the specified memory.

8. A scheduler according to claim 7, wherein the evaluator is arranged to monitor termination of tasks, and in response to a task terminating, to identify whether there is sufficient memory to execute the remaining tasks.

9. A scheduler according to claim 7, wherein the data identifies an execution deadline associated with the task.

10. A scheduler according to claim 9, wherein, in response to the evaluator identifying sufficient memory to execute the remaining tasks, the scheduler is arranged to identify a task without an execution deadline and schedule the identified task.

11. A scheduler according to claim 8, wherein, in response to the evaluator identifying sufficient memory to execute the remaining tasks, the selector is arranged to deselect said selected one or more tasks.

12. A data processing system arranged to execute a plurality of tasks, comprising:
memory arranged to hold instructions and data during execution of a task;
receiving means arranged to receive data identifying maximum memory usage associated with a task;
evaluating means arranged to identify, on the basis of the received data, whether there is sufficient memory to execute the tasks; and
a scheduler arranged to schedule execution of the tasks on the basis of input received from the evaluating means,
wherein, in response to identification of insufficient memory to execute the plurality of tasks, the scheduler is arranged to suspend execution of at least one task in dependence on memory usage by the task.

13. A data processing system according to claim 12, further comprising a digital television system.

14. A method of transmitting data to a data processing system, the method comprising:
transmitting data for use by the data processing system in processing a task; and
transmitting suspension data specifying suspension of the task based on memory usage during processing thereof,
wherein the data processing system is arranged to perform a process comprising:
monitoring for an input indicative of memory usage of the task matching the suspension data associated with the task; and
suspending processing of said task on the basis of said monitored input.

15. A method according to claim 14, wherein the suspension data identifies at least one point at which processing of the task can be suspended, based on memory usage of the task.

16. A method according to claim 14, wherein the suspension data includes data identifying maximum memory usage associated with the task.

17. A method according to claim 15, wherein the task comprises a plurality of sub-jobs and said data identifying at least one point at which processing of the task can be suspended corresponds to each such sub-job.

18. A method of configuring a task for use in a data processing system, the method including associating suspension data with the task, the suspension data specifying suspension of the task based on memory usage associated therewith, wherein the data processing system is arranged to perform a process in respect of a plurality of tasks, the process comprising:
monitoring for an input indicative of memory usage of the task matching the suspension data associated with the task; and
suspending processing of said task on the basis of said monitored input.

19. A method according to claim 18, further comprising identifying a data processing system configured to process the task and transmitting said suspension data to the data processing system.

20. A computer program comprising a set of instructions arranged to cause a processing system to perform the method according to claim 1.
